(19) United States
(12) Patent Application Publication
(10) Pub. No.: US 2016/0378931 A1
(43) Pub. Date: Dec. 29, 2016

(54) METHODS AND SYSTEMS FOR COMPARING AND MATCHING MEDICAL TREATMENT VERSUS DIAGNOSIS AND/OR OTHER INDICATORS RELATED TO MEDICAL TREATMENT AND/OR DIAGNOSIS

(71) Applicant: PRX Control Solutions, LLC, Miami, FL (US)

(72) Inventor: Alfredo Luis Vaamonde, Miami, FL (US)

(21) Appl. No.: 15/177,769

(22) Filed: Jun. 9, 2016

Related U.S. Application Data
(60) Provisional application No. 62/183,579, filed on Jun. 23, 2015.

(51) Int. Cl. G06F 19/00

(52) U.S. Cl. CPC G06F 19/328; G06F 19/325; G06F 19/345; G06F 19/326

(57) ABSTRACT

An audit system may audit a medical treatment. The audit system may receive data describing a transaction comprising one or more diagnoses and one or more treatments. The audit system may audit the transaction to identify a treatment within the one or more treatments that does not correspond to any of the one or more diagnoses. The audit system may generate an anomaly report for the identified treatment. The audit system may provide the anomaly report to a treatment fulfillment system prior to fulfillment of the treatment, thereby preventing fulfillment of the treatment and/or changing an entity billed for the treatment.

### CROSS REFERENCE TO RELATED APPLICATION

This application claims priority to U.S. Provisional Application Ser. No. 62/183,579 filed Jun. 23, 2015, the entirety of which is incorporation herein by reference.

### SUMMARY OF THE DISCLOSURE

The disclosed embodiments may allow health plans and/or payer, pharmacy benefit managers (PBM) to compare and match diagnosis versus prescriptions drugs; identifying abuse, waste, missing diagnosis, and misuse of pharmaceutical treatments. Health plans may treat medical claims, which contain the diagnosis of the patient, independently from pharmacy claims, which contain the prescription and drugs dispensed to the patient by the pharmacy. Comparing medical claims with pharmacy claims may allow health plans to detect if the prescriptions are truly needed by the patient, for example by identifying the diagnosis and comparing it to the treatment. With the disclosed embodiments, payers, pharmacy benefit managers, and/or health plans may be able to compare and match medical claims with pharmacy claims, identifying which treatments should not be approved and thus, should be covered by the patient.

The disclosed embodiments relate to and provide a cloud based software application that may reduce drug benefit costs, may improve patient's quality of care, and may control the expense and intake of pharmaceutical treatments in health plans by detecting more than twenty five types of anomalies in prescriptions and pharmacy invoices. Thus, the disclosed embodiments may provide users of the disclosed method, system, or application with millions of dollars in savings by identifying abuse and waste in prescriptions. The disclosed embodiments may be suitable for use by payers, employers, pharmacy benefit managers (PBM), insurance companies, third party administrators, health plan providers, government institutions or any other organization that offers a health plan, to name a few.

The disclosed embodiments may utilize a method that compares medical claims with pharmacy claims to detect improper prescriptions, abuse, waste, unneeded treatments, uses, excess dosages, and other anomalies. The disclosed method may utilize more than twenty-five different variables during its analysis; examples of which include, but are not limited to: drug brand, active ingredient, gender and age of the patient, and a doctor's diagnosis of the patient, to name a few.

### BRIEF DESCRIPTION OF THE DRAWINGS

FIG. 1 is an example workflow for a diagnosis versus treatment function.

FIG. 2 is an example prescription auditing process.

FIG. 3 is an example prescription dispensing process.

FIG. 4 is an example processed claim auditing process.

FIG. 5 is an example auditing system.

FIG. 6 is an example server configured to provide one or more auditing system features.

FIG. 7 is an example auditing process.

FIG. 8 is an example drug-diagnosis matching process.

FIG. 9 is an example missing diagnosis/non-matching drug evaluation process.

FIG. 10 is an example anomaly detection process.

FIG. 11 is an example birth control anomaly detection process.

FIG. 12 is an example erectile dysfunction anomaly detection process.

FIG. 13 is an example overdose anomaly detection process.

FIG. 14 is an example frequency anomaly detection process.

FIGS. 15-18 are example user interface screenshots.

### DETAILED DESCRIPTION OF SEVERAL EMBODIMENTS

Throughout this application, the terms drugs and medication will be used interchangeably. It should be appreciated that a prescribed treatment may include a prescribed drug or medication. It should also be appreciated that references to a disease or diseases may also include other ailments or injuries that are not necessarily associated with a disease. As such, the disclosed embodiments are not to be limited solely to a diagnosis of a disease and treatments of diseases and that other medical evaluations and treatments may be audited and processed by the disclosed embodiments.

The disclosed embodiments may audit one or more of the following situations: diagnosis versus treatment; gender and age of the patient versus treatment; a doctor's treatment directions (e.g., dosage, frequency, duration); prescribed drugs versus purchased drugs; drug prices; and market rules (e.g., prescription of vitamins, natural products, amino acids, cosmetics, etc.). The disclosed embodiments may automatically match medical claims with prescription claims or to audit a diagnosis versus treatment, which is a substantial advantage that the disclosed embodiments provide over existing and prior methods.

The disclosed embodiments may provide the ability to detect one or more of the following anomalies: the treatment is not related to the diagnosis; the excessive prescription of a medication; opioid abuse and/or waste; self-medication; the treatment is not suitable for the patient (e.g., by gender or age); the prescription or purchase of treatments for losing weight; prescription or purchases against erectile dysfunction; the prescription or purchase of multivitamins; the prescription or purchase of herbal products; the prescription or purchase of drugs against tobacco addiction; the prescription or purchase of skin care products; the prescription or purchase of sedatives or anxiolytics; the prescription or purchase of non-pharmaceutical products; overpriced drugs; the prescription or purchase of products not covered by the health plan; the prescription or purchase of drugs with overdose (i.e., the indicated dosage exceeds the maximum allowed by the treatment); the prescription or purchase of birth control drugs; the prescription or purchase of nutritional supplements; the prescription or purchase of appetite stimulants; the prescription or purchase of homeopathic products; the prescription or purchase of adaptogens; the indications for the prescription exceed the maximum allowed; the diagnosis is not covered by the health plan; the doctor's specialty does not relate to the diagnosis; and the patient is missing diagnosis codes regarding his or her prescription.

The disclosed embodiments may utilize one or more of the following parameters during the analyses described herein: diagnosis (e.g., International Classification of Diseases (ICD) codes); drugs (e.g., NDC codes): brands, presentation (i.e., dosage, dosage form), type of drug, active ingredient(s), therapeutic classes, doctor's indications (e.g., dosage, frequency, duration), and unit price, to name a few; and patient information (e.g., gender, date of birth, etc.).

The disclosed embodiments may be used for any health plan, by e.g., insurance companies, third party administrators, prescription benefit managers (PBM), government institutions, and employers, to name a few. Individual users of the disclosed embodiments (i.e., individuals who input the information required by the embodiments to be used e.g., for the pharmaceutical analysis of the pharmacy claim) may include e.g., analysts (e.g., analysts that work the health plan and are in charge of analyzing medical and pharmacy claims); doctors (e.g., prescribers that enter the information sent to the disclosed embodiments by e.g., a web-service); pharmacists (e.g., pharmacists that enter prescription information into PBM software, which is then sent to the disclosed embodiments by e.g., a web-service); pharmacy technicians (e.g., pharmacy technicians that enter prescription information into PBM software, which is then sent to the disclosed embodiments by e.g., a web-service); patients (i.e., patients can also be users of the disclosed embodiments if e.g., the health plan offers a do-it-yourself option for refilling prescriptions).

The disclosed systems and methods may include diagnosis versus treatment (e.g., drug) auditing functionality. The functionality may use the International Classification of Diseases (ICD) set out by the World Health Organization (WHO) to group the different types of possible diagnoses for analysis. For example, the disclosed embodiments may utilize type of disease (1-2)—chapters from the ICD, grouping the different types of diseases; and disease (i.e., the name of the disease documented by the ICD). In some embodiments, the diagnosis is not limited to diseases and may include other ailments or conditions that are not classified as a disease in the ICD.

The diagnosis versus treatment auditing functionality may also use the Anatomical Therapeutic Chemical (ATC) Classification System from the WHO to group different types of drugs as follows: therapeutic class (1-4) (e.g., the therapeutic classes that group all the active ingredients registered under the ATC); active ingredient of the drug; brand (e.g., the name of the brand of the drug); medication (e.g., complete presentation of the drug with dosage and dosage form); priority (Drug-TC) (e.g., the priority of the function of the drug for a specific therapeutic class); and priority (TC-TD2) (e.g., the priority of the function of a specific therapeutic class for a type of disease).

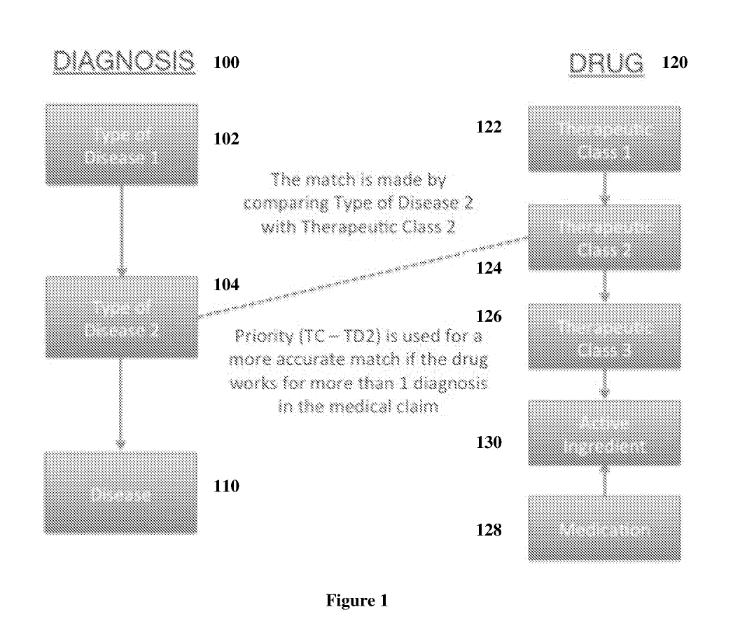

An example workflow for the diagnosis versus treatment function is illustrated in FIG. 1. The diagnosis 100 may be analyzed to determine e.g., what type of disease 110 or ailment is being treated and then compared to the drug (treatment) 120 prescribed. How this information is input into the disclosed embodiments, and the types of system architecture and interfaces used, is explained below. The diagnosis 100 may include one or more disease characteristics 102, 104 that may help define the disease 110. Additionally, the prescribed drug 120 may include one or more therapeutic classes 122, 124, 126 and/or medication names 128 that may help define an active ingredient 130. The diagnosis 100 features 102, 104 and drug 120 features 122, 124, 126, 128 may be compared. For example, a determination that a “Type of Disease 2” 104 has been input/determined, which is then matched to a corresponding drug (treatment) 120. In the illustrated example, a match is made by comparing the “Type of Disease 2” 104 with “Therapeutic Class 2” 124. FIG. 1 also indicates that the drug (treatment) 120 could also include a Priority (TC-TD2) to obtain a more accurate match when the identified drug can be used for more than one diagnosis 100 in the medical claim.

In some embodiments, the disclosed system and method can be implemented at least in part using an application program that can be downloaded onto a mobile device (e.g., smartphone, PDA, tablet, laptop, personal computer, etc.) and accessed by a user via the mobile device. The application program, referred to herein as the “PCA Audit application,” may allow the mobile device to interact with a system server to perform certain functions of the method disclosed herein. In some embodiments, the disclosed system and method can be implemented at least in part using a website (e.g., PCA-AUDIT.com) operated by a server accessible by a user device (e.g., smartphone, PDA, tablet, laptop, personal computer, etc.) or online application over the Internet or other network. This website is referred to herein as the “PCA Audit website.” In some embodiments, the disclosed method can be implemented as (or integrated with) part of another software application such as e.g., a health plan's management system or an insurance company's management/auditing system, to name a few. In some embodiments, PCA Audit may be integrated into any software with an open standard format (e.g.: JSON) that uses human-readable text to transmit data objects consisting of attribute-value pairs. The open standard software may be used to transmit data between a server and web application, as an alternative to XML, for example. Examples of data received and sent by PCA Audit through a web-service to an e-prescribing or PBM solution are listed below in Table I. Because the disclosed system and methods can be implemented in many combinations of hardware, software, and/or firmware, the processing described in the following description (and the figures) will simply use the phrase “PCA Audit” as a short form that applies to any of the possible implementations.

When a user interacts with PCA Audit for the first time, the user may be prompted to create an account with the PCA Audit system. The account may be associated with a username and password specifically created for the PCA Audit system and application.

The disclosed embodiments provide many potential uses for controlling the abuse of pharmaceutical treatments in health plans and providing key analytics for strategic decision making. The disclosed embodiments may alert the user when there are treatments that are not covered by the health plan, for example. The disclosed embodiments may also detect if a diagnosis is not related to the prescription, alerting the pharmacy not to dispense the treatment under the health plan. When a treatment is not to be dispended under the health plan, the disclosed embodiments may notify the user that the patient should pay for the treatment instead of the health plan (i.e., the patient can pay for the treatment out-of-pocket if desired).

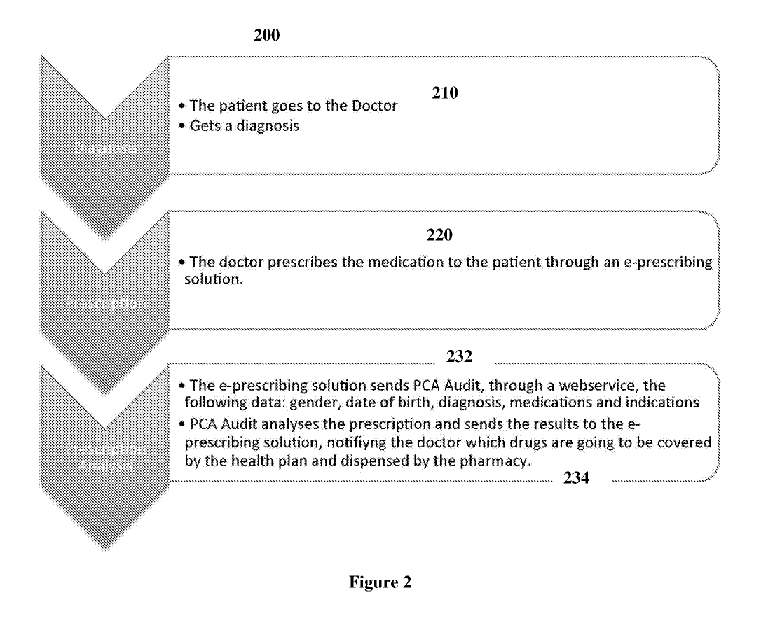

FIG. 2 illustrates an example process 200 for auditing a prescription. As is explained below in more detail, one or more of the disclosed embodiments (referred to as “PCA Audit” in the Figures) can integrate with or into an e-prescribing solution/service (e.g., Surescripts at www.surescripts.com). According to the FIG. 2 process 200, the disclosed embodiments can detect anomalies before a doctor prescribes the treatment to the patient. A doctor may examine a patient and arrive at a diagnosis 210. The doctor may prescribe the treatment medication through an e-prescribing solution 220, which may gather gender, date of birth, diagnosis, medications, indications, and/or other information. The e-prescribing solution may send this information to PCA Audit using a webservice 232, for example. PCA Audit may analyze the prescription and send the results to the e-prescribing solution 234, notifying the doctor which drugs are going to be covered by the health plan and dispensed by the pharmacy. Alerts concerning anomalies can also be sent back to the doctor.

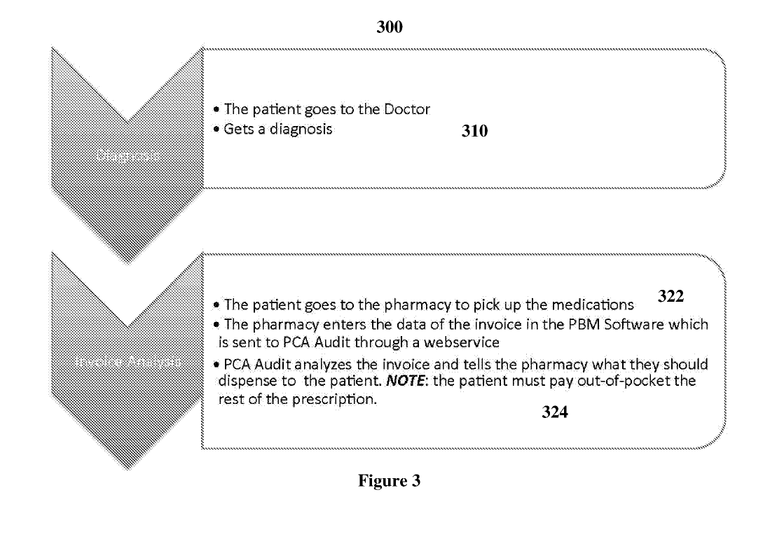

FIG. 3 illustrates an example process 300 for dispensing a prescription. In this embodiment, PCA Audit can be integrated to the software of the Prescription Benefit Manager (e.g., Surescripts, OptumRx). Moreover, in this embodiment, PCA Audit can detect anomalies before a pharmacy dispenses the treatment to the patient. A doctor may examine a patient and arrive at a diagnosis 310. The doctor may prescribe a treatment, and the patient may go to the pharmacy to get the prescription filled. The pharmacy may enter the prescription in the PBM Software, and the prescription may be sent to PCA Audit through a webservice 322. PCA Audit may analyze the prescription and advise the pharmacy what medications should be dispensed to the patient 324. It will be the patient's responsibility to pay for any portion of the prescription not covered. Alerts concerning anomalies can also be issued to the pharmacy if desired.

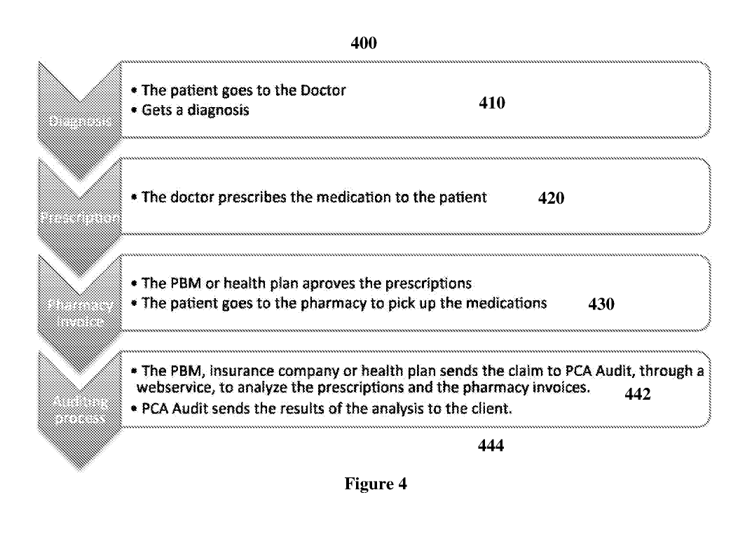

FIG. 4 illustrates an example process 400 for an auditing service for e.g., health plan providers. The process 400 may detect anomalies in dispensed prescriptions and pharmacy invoices after the patient already received the treatment. A doctor may diagnose a patient 410 and prescribe a treatment 420. The PBM or health plan may approve the treatment, and the patient may attempt to pick up the medication 430. As shown in FIG. 4, the PBM, insurance company, or health plan service/system may the claims to PCA Audit, through e.g., a webservice 442. PCA audit may analyze the prescriptions and the pharmacy invoices and send the results of the analysis and any alerts to the user 444. In some embodiments, PCA Audit may return the results of the analysis in fully interactive custom made dashboards.

Table 1 illustrates examples of the type of data that may be received by and transmitted from the PCA Audit system (through a webservice to an e-prescribing or PBM solution/service, for example). This information can be stored in one or more of the databases described above and used by the PCA Audit method to perform the various analysis discussed herein.

TABLE 1

| DATA SENT BY THE E-PRESCRIBING | DATA SENT BY PCA |
|---|---|
| OR PBM SOULTION | AUDIT |
| ID transaction | ID transaction |
| Gender of the patient | Approved drugs (NDC code) |
| Date of birth of the patient | Quantity of approved drugs |
| ID Diagnosis (ICD 9-10) | Rejected drugs (NDC code) |
| Prescribed drugs (NDC code) | Quantity of rejected drugs |
| Quantity | Anomalies detected |
| Unit price | Total Savings |
| ID patient | |
| Physician | |
| Pharmacy | |
| Pharmacy location (zip code) | |

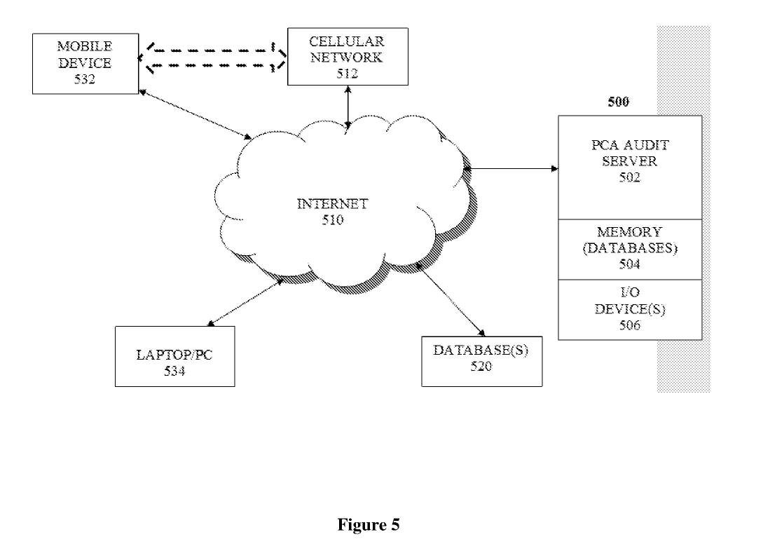

In some embodiments, the above described processing is implemented in software (i.e., computer instructions) that are stored in a computer readable memory and executed by a processor on e.g., a server. FIG. 5 illustrates an example auditing system 500 comprising a PCA Audit server 502 configured to perform the processing disclosed herein. The server 502 includes or is connected to a memory 504 for storing computer instructions for implementing the method described herein and to store the various databases, user information, and verification algorithms used during the above-described processes. The server 502 can include input/output devices 506 such as displays, scanners, printers, etc. The server 502 can be accessed over a wired or wireless network 510 (shown as the Internet in this example) and/or a cellular network 512. User devices may include a mobile device 532, laptop or PC 534, or other device that may connect to the server 502 via the network 510/512. In some embodiments, each client (e.g., a registered user of one or more devices 532/534) may have access to an app for interfacing with the system 500 through the network 510/512 hosted on a separate server 502 or server instance. The illustrated databases include at least the client data database 520, which may be accessible to the server 502 through the network 510/512, and the PCA Audit centralized database 504 discussed above. In this example, system 500 may use the centralized database for user management, while client data may be stored in separate databases 520 (e.g., each client may have its own database). System 500 may generate reports of irregularities detected specific to each client, thereby detecting fraud that may otherwise cost the client money. PCA Audit is integrated to any software with e.g., an open standard format (e.g., JSON) that uses human-readable text to transmit data objects consisting of attribute-value pairs. It may be used primarily to transmit data between a server and web application (e.g., the irregularity report data), as an alternative to XML.

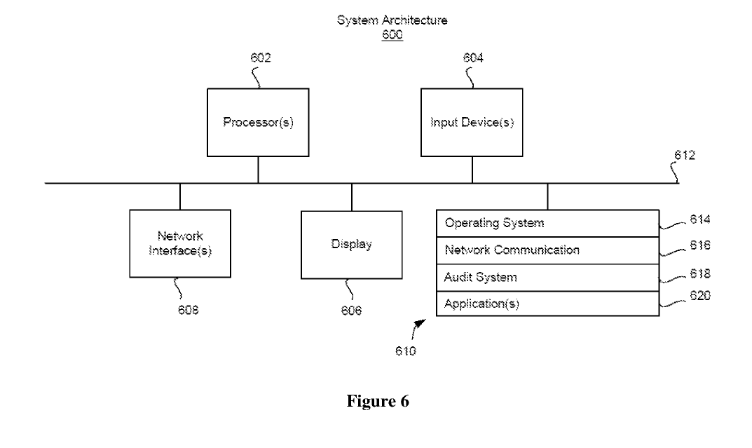

FIG. 6 is a block diagram of an example system architecture 600 implementing the features and processes described herein. For example, the architecture 600 may provide one or more elements of the system 500 of FIG. 5, such as the server 502. The architecture 600 may be implemented on any electronic device that runs software applications derived from compiled instructions, including without limitation personal computers, servers, smart phones, media players, electronic tablets, game consoles, email devices, etc. In some implementations, the architecture 600 may include one or more processors 602, one or more input devices 604, one or more display devices 606, one or more network interfaces 608, and one or more computer-readable mediums 610. Each of these components may be coupled by bus 612.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, and touch-sensitive pad or display. Bus 612 may be any known internal or external bus technology, including but not limited to ISA, EISA, PCI, PCI Express, NuBus, USB, Serial ATA or FireWire. Computer-readable medium 610 may be any medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 610 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 may establish and maintain network connections (e.g., software for implementing communication protocols, such as TCP/IP, HTTP, Ethernet, etc.).

An audit system 618 can include instructions that may generate and provide server instances that use or implement the PCA Audit processes described herein. For example, the audit system 618 may perform the detailed auditing processes described in greater detail below.

Application(s) 620 may be an application that uses or implements the processes described herein. The processes may also be implemented in operating system 614.

The following processes may be implemented by system 500 (and, therefore, architecture 600) to provide the features described above, for example auditing drug and/or diagnosis data for a variety of anomalies.

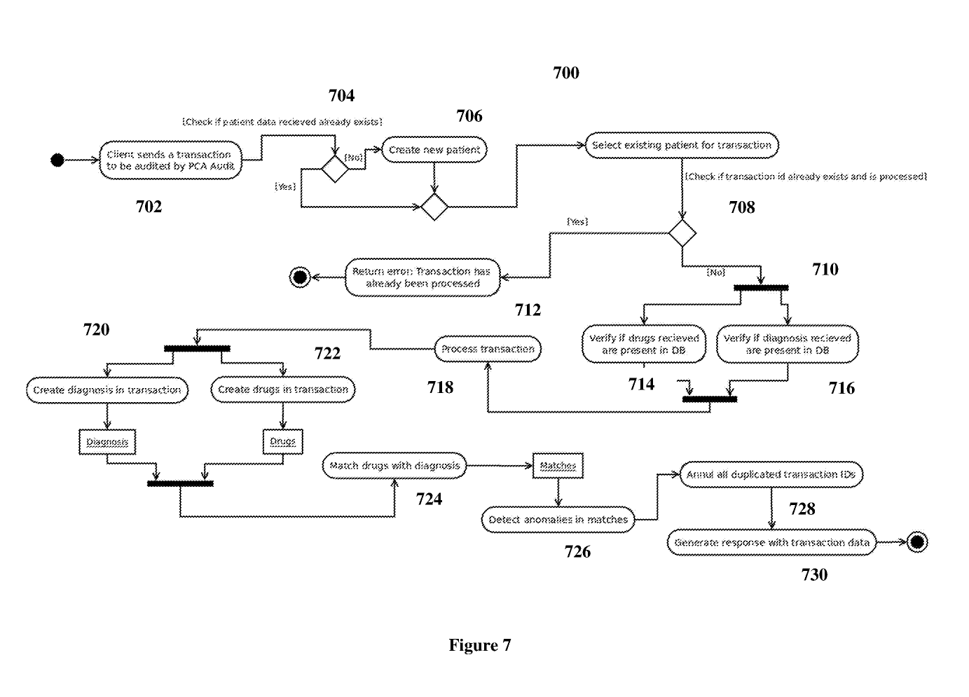

FIG. 7 illustrates an example auditing process 700. In 702, system 500 may receive a transaction to be audited from a client (e.g., from device 532/534). In 704, system 500 may check whether patient data in the received transaction already exists within system 500. If not, in 706, system 500 may create a new patient. In 708, system 500 may select the newly created or preexisting identified patient for the transaction.

In 710, system 500 may check whether the transaction being audited already exists and has already been processed. If so, in 712, system 500 may return an error message to client device 532/534 indicating that the transaction has been processed. If not, in 714, system 500 may verify whether the drugs identified in the transaction are in the system 500 database. Also, in 716, system 500 may verify whether the diagnoses identified in the transaction are in the system 500 database. If either is not in the database, an error may be returned.

Otherwise, in 718, system 500 may process the transaction. For example, in 720, system 500 may analyze the diagnosis information in the transaction to isolate one or more specific diagnoses. In 722, system 500 may analyze the drug information in the transaction to isolate one or more specific drugs. In 724, system 500 may identify any matches between the identified drugs and diagnoses. In 726, system 500 may identify anomalies in the matches. In 728, system 500 may remove duplicate transaction data. Finally, in 730, system 500 may generate a response comprising the transaction data, which may include matches and anomalies that have been identified, and send the response to client device 532/534.

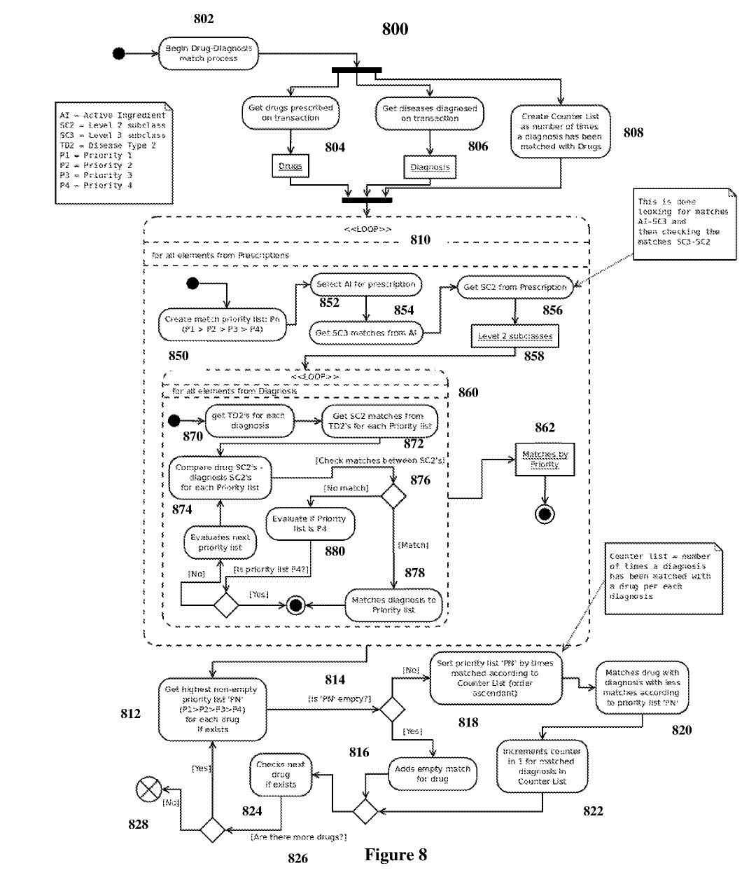

FIG. 8 is an example drug-diagnosis matching process 800. For example, in step 724 of process 700, system 500 may perform the processing of the drug-diagnosis matching process 800 described in FIG. 8.

In 802, system 500 may begin the process 800. In 804, system 500 may determine the drugs prescribed in the transaction, and in 806, system 500 may determine the diagnoses in the transaction. In 808, system 500 may create a counter list indicating a number of times each diagnosis has been matched with each drug.

In 810, system 500 may loop through all elements from prescriptions and diagnoses to identify matches. This loop is described in greater detail below. The results of this processing may include a set of matches between drugs and diagnoses which may be arranged by priority.

In 812, system 500 may select the highest non-empty priority list for each drug. In 814, system 500 may identify any drug that has no non-empty priority list and, in 816, may add an empty match entry for that drug. For a drug having a non-empty priority list, in 818, system 500 may sort the priority list by times matched according to counter list. In 820, system 500 may match the drug with the diagnosis having fewer matches according to the priority list. In 822, system 500 may increment a counter and, in 824, determine if another drug exists. In 826, if more drugs exist in the transaction, system 500 may repeat processes 812-822 for each existing drug. When all drugs have been matched, in 828, system 500 may end the process 800 and continue the overall audit process 700.

Loop 810, which may identify matches, may proceed as follows for each drug. In 850, system 500 may create a match priority list (e.g., rank priorities in order of importance). In 852, system 500 may select an active ingredient for the drug. In 854, system 500 may match level 3 subclasses with the active ingredient. In 854, system 500 may match level 2 subclasses with the identified matching level 3 subclasses. In 858, system 500 may generate a valid set of level 2 subclasses for the drug from the matching. For each drug, system 500 may perform a diagnosis loop 860 to determine whether each diagnosis in the transaction matches the drug. In 862, system 500 may create a list ranking the resulting set of drug and diagnosis matches by priority.

Loop 860 may proceed as follows for each diagnosis. In 870, system 500 may identify a disease type for the diagnosis. In 872, system 500 may identify level 2 subclass matches for the disease type for the drug priority lists. In 874, system 500 may compare the matching drug level 2 subclasses and diagnosis level 2 subclass. In 876, system 500 may identify matches between the level 2 subclasses. If there is a match, in 878, system 500 may match the diagnosis to the priority list being evaluated, and loop 860 may end for this diagnosis. If no matches, in 880, system 500 may evaluate whether the priority for the drug being analyzed is priority 4. If not, in 884, system 500 may select a next drug priority list and repeat steps 874-882 for the next list. If so, loop 860 may end for this diagnosis.

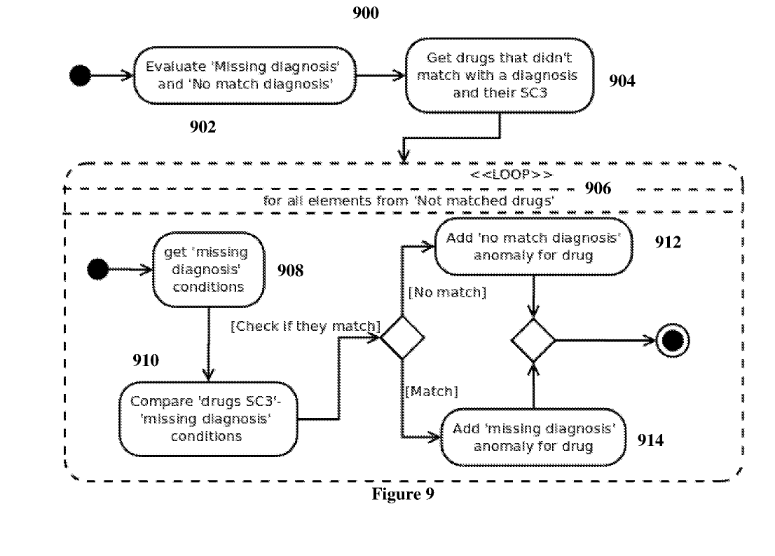

FIG. 9 is an example missing diagnosis/non-matching drug evaluation process 900. System 500 may perform this process 900 in the event that a drug in a transaction does not match any diagnosis in the transaction after performing process 800.

In 902, system 500 may determine that at least one drug has no corresponding matching diagnosis in the transaction. In 904, system 500 may get the level 3 subclass information for the non-matching drugs. System 500 may perform loop 906 for each non-matching drug.

Loop 906 may proceed as follows. In 908, system 500 may identify a set of missing diagnosis conditions for the non-matching drug. These conditions may define diagnoses that are valid for the drug but not present in the transaction, for example. In 910, system 500 may compare the level 3 subclass information for the drug with the missing diagnosis conditions. If there is no match, in 912, system 500 may generate a non-matching drug anomaly notice for the drug. If there is a match, in 914, system 500 may generate a missing diagnosis anomaly notice for the drug.

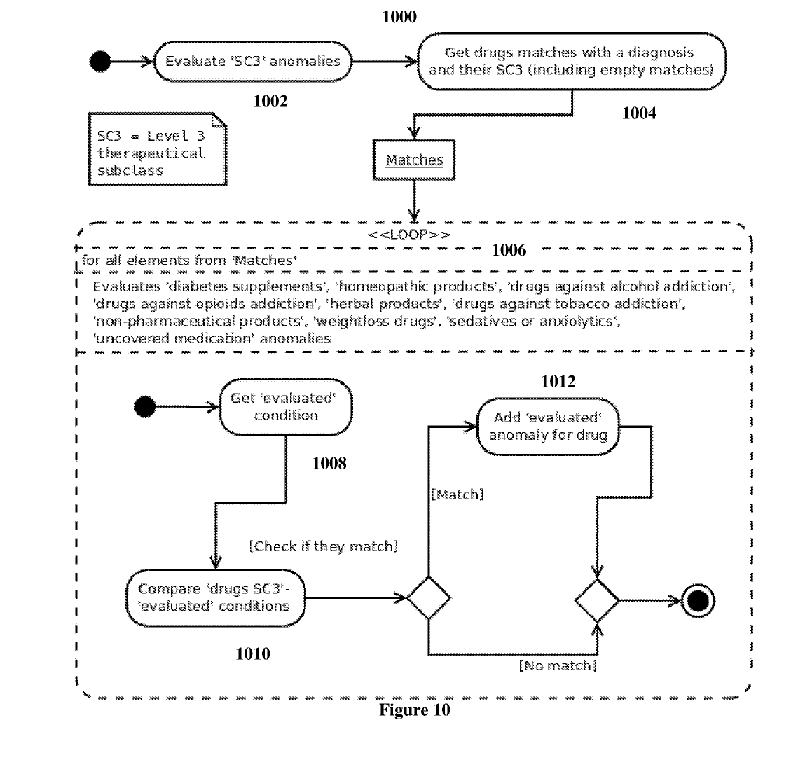

FIG. 10 is an example anomaly detection process 1000. Drugs in a transaction may be evaluated for the presence of a variety of anomalies, such as those described above. In 1002, system 500 may begin anomaly detection. In 1004, system 500 may get the drugs from a transaction, both those matching diagnoses and those without matches (i.e., empty matches). For each drug, system 500 may perform loop 1006.

Loop 1006 may proceed as follows. In 1008, system 500 may get an evaluated condition (e.g., an anomaly). In 1010, system 500 may compare the drug's level 3 subclass with the evaluated condition. If there is a match, in 1012, system 500 may generate a notification indicating the presence of an anomaly for the drug. For example, anomalous drugs may not be distributed or may not be covered by a user's insurance. In the latter case, the user may be directly charged for the anomalous drugs.

Some example anomalies may be as follows: the treatment doesn't match the diagnosis; missing diagnosis; the treatment is not for the patient (by gender or age); opioid abuse; drug interactions; prescriptions of weight loss products; prescriptions against erectile dysfunction; prescriptions of multivitamins; prescriptions of herbal products; prescriptions of drugs against tobacco addiction; prescriptions of skin care products; prescriptions of sedatives or anxiolytics; prescriptions of non-pharmaceutical products; prescriptions of drugs against alcohol addiction; prescriptions of drugs against opioid addiction; prescriptions of products not covered by the health plan; prescriptions of drugs with overdose; prescriptions of birth control drugs; prescriptions of nutritional supplements; prescriptions of appetite stimulants; prescriptions of homeopathic products; prescriptions of adaptogens; the directed amount for the prescription exceeds the maximum allowed; the diagnosis is not covered by the health plan; the doctor's specialty does not relate to the diagnosis.

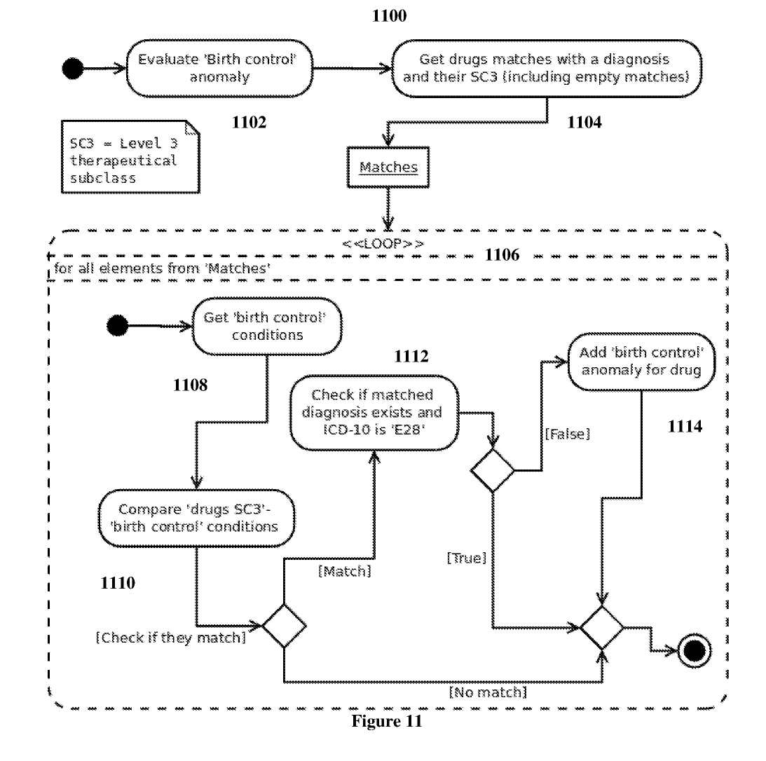

System 500 may perform specific anomaly processing for some drug types. FIG. 11 is an example birth control anomaly detection process 1100. This process 1100 may be performed when a transaction involves a birth control drug, for example.

In 1102, system 500 may begin birth control drug anomaly evaluation. In 1104, system 500 may get the drugs from a transaction, both those matching diagnoses and those without matches (i.e., empty matches). For each drug, system 500 may perform loop 1106.

Loop 1106 may proceed as follows. In 1108, system 500 may identify one or more birth control conditions. In 1110, system 500 may compare the drug's level 3 subclass with the birth control conditions. If there is a match, in 1112, system 500 may determine whether a diagnosis conflicting with a birth control prescription (e.g., an ovarian dysfunction diagnosis) is present in the transaction. If not, in 1114, system 500 may generate a notification indicating the presence of an anomaly for the drug, because birth control pills may often not be covered by health plans unless there is an ovarian dysfunction.

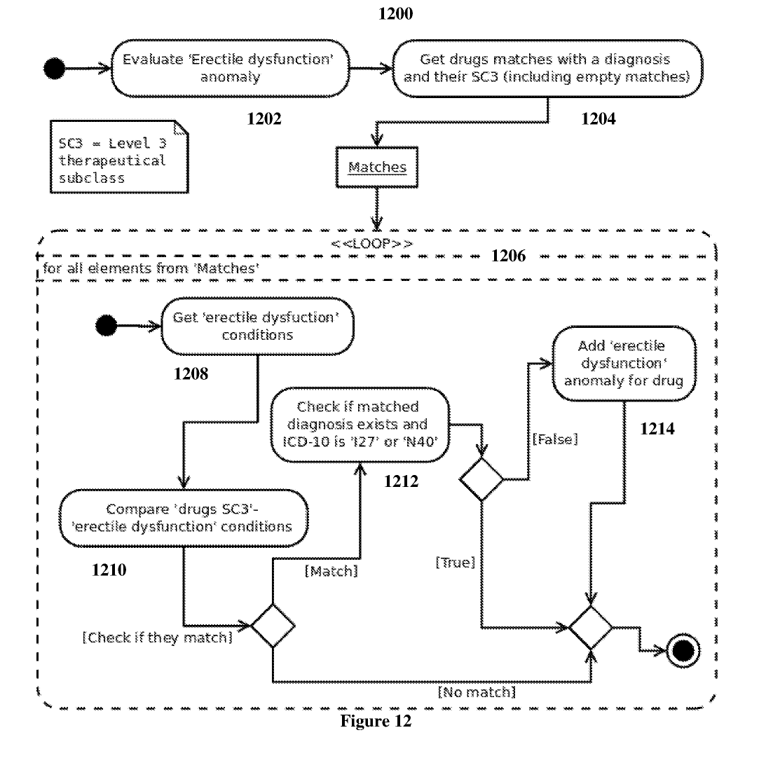

FIG. 12 is an example erectile dysfunction anomaly detection process 1200, another example of specific anomaly processing system 500 may perform. This process 1200 may be performed when a transaction involves an erectile dysfunction drug, for example.

In 1202, system 500 may begin erectile dysfunction control drug anomaly evaluation. In 1204, system 500 may get the drugs from a transaction, both those matching diagnoses and those without matches (i.e., empty matches). For each drug, system 500 may perform loop 1206.

Loop 1206 may proceed as follows. In 1208, system 500 may identify one or more erectile dysfunction conditions. In 1210, system 500 may compare the drug's level 3 subclass with the erectile dysfunction conditions. If there is a match, in 1212, system 500 may determine whether a diagnosis conflicting with an erectile dysfunction prescription (e.g., a primary pulmonary hypertension or an enlarged prostate) is present in the transaction. If not, in 1214, system 500 may generate a notification indicating the presence of an anomaly for the drug, because erectile dysfunction pills may often not be covered by health plans unless there is a primary pulmonary hypertension or an enlarged prostate.

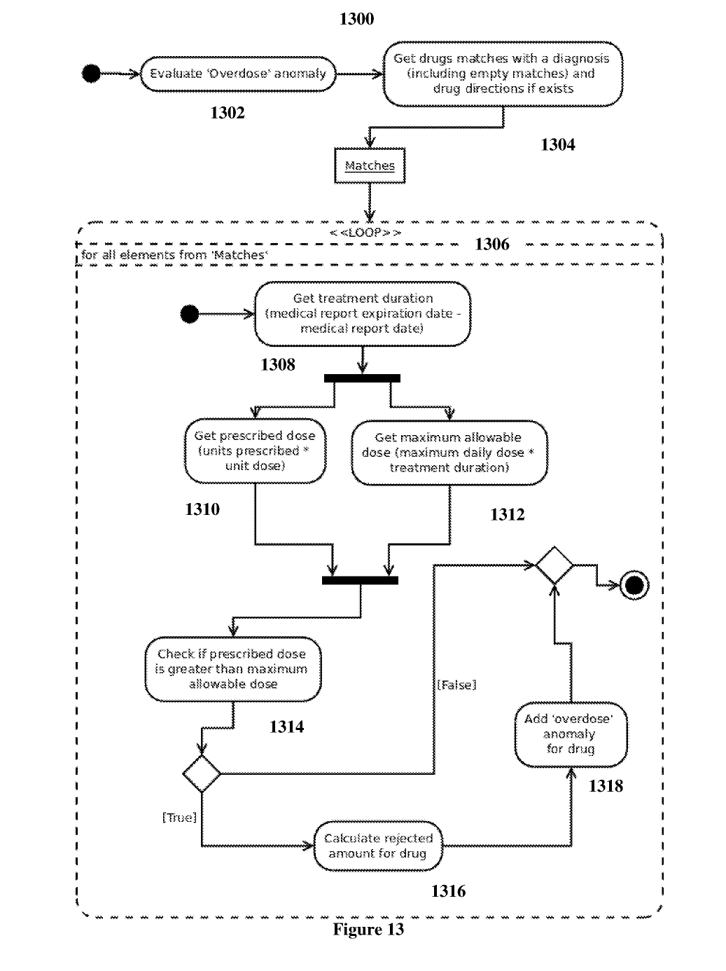

System 500 may also detect other types of anomalies related to drugs. FIG. 13 is an example overdose anomaly detection process 1300. In 1302, system 500 may begin overdose anomaly evaluation. In 1304, system 500 may get the drugs from a transaction, both those matching diagnoses and those without matches (i.e., empty matches). For each drug, system 500 may perform loop 1306.

Loop 1306 may proceed as follows. In 1308, system 500 may identify a duration associated with a treatment in the transaction. In 1310, system 500 may identify a prescribed drug dose from the transaction, and in 1312, system 500 may identify a maximum allowable dose associated with the drug. In 1314, system 500 may determine whether the prescribed dose exceeds the maximum allowable dose. If so, in 1316, system 500 may calculate the rejected amount for the drug (e.g., the amount of prescribed dosage over the maximum allowable) and, in 1318, system 500 may generate an indication of overdose anomaly for the drug.

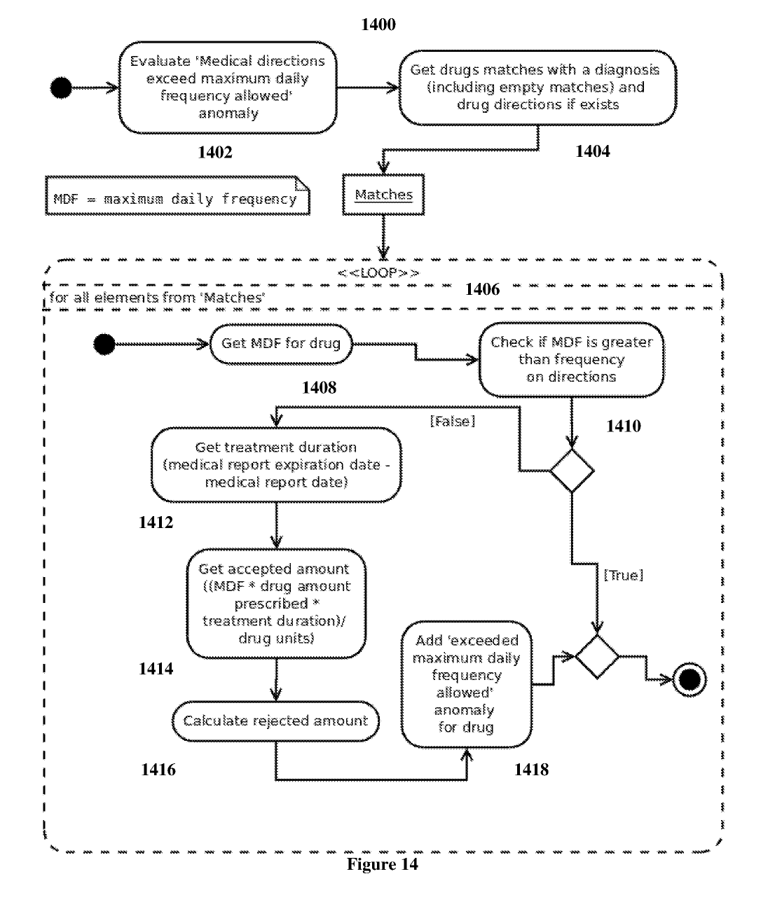

FIG. 14 is an example frequency anomaly detection process 1400. In 1402, system 500 may begin frequency anomaly evaluation. In 1404, system 500 may get the drugs from a transaction, both those matching diagnoses and those without matches (i.e., empty matches). For each drug, system 500 may perform loop 1406.

Loop 1406 may proceed as follows. In 1408, system 500 may identify a maximum daily frequency associated with the drug. In 1410, system 500 may determine whether the maximum daily frequency is greater than the prescribed frequency for the drug. If not, in 1412, system 500 may identify the treatment duration for the diagnosis related to the drug in the transaction. In 1414, system 500 may determine an accepted amount of drug frequency based on the maximum daily frequency. In 1416, system 500 may calculate the rejected amount for the drug (e.g., the amount of prescribed dosage putting the total prescribed amount over the accepted amount of drug frequency) and, in 1418, system 500 may generate an indication of excessive maximum daily frequency anomaly for the drug.

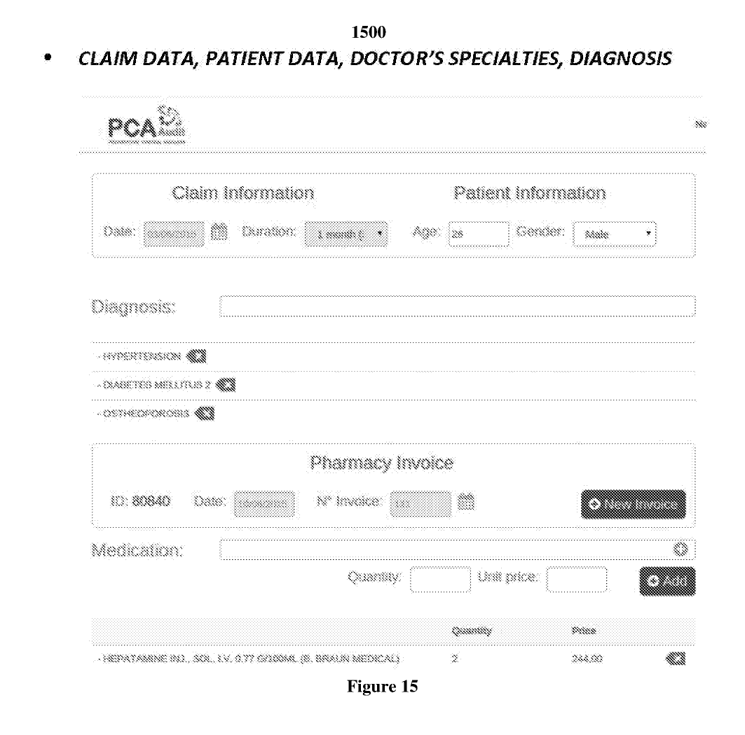

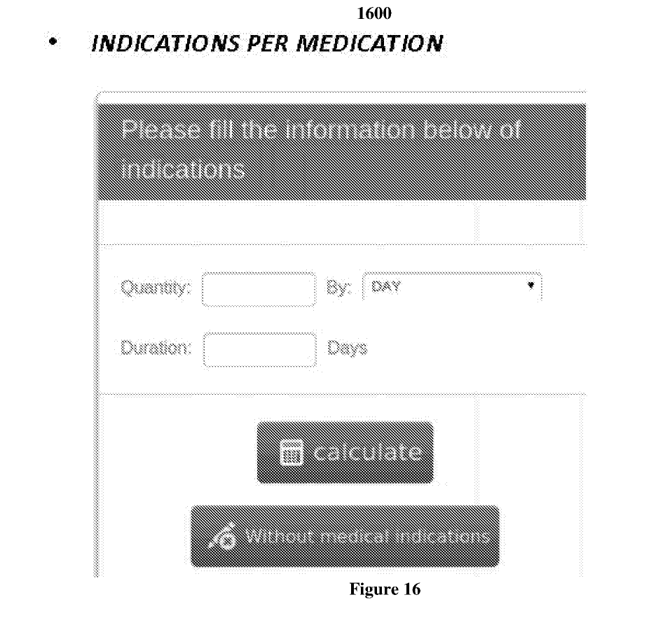

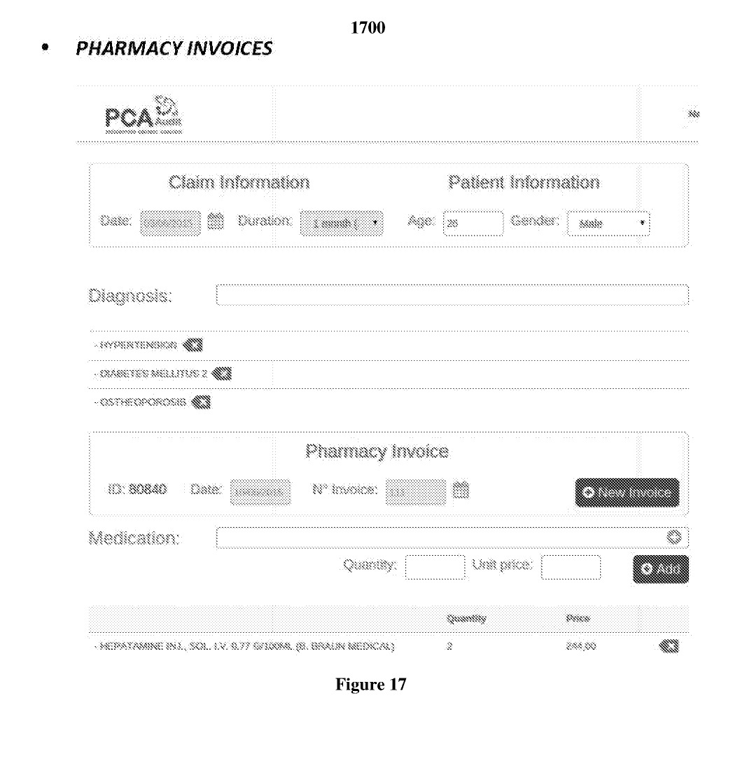

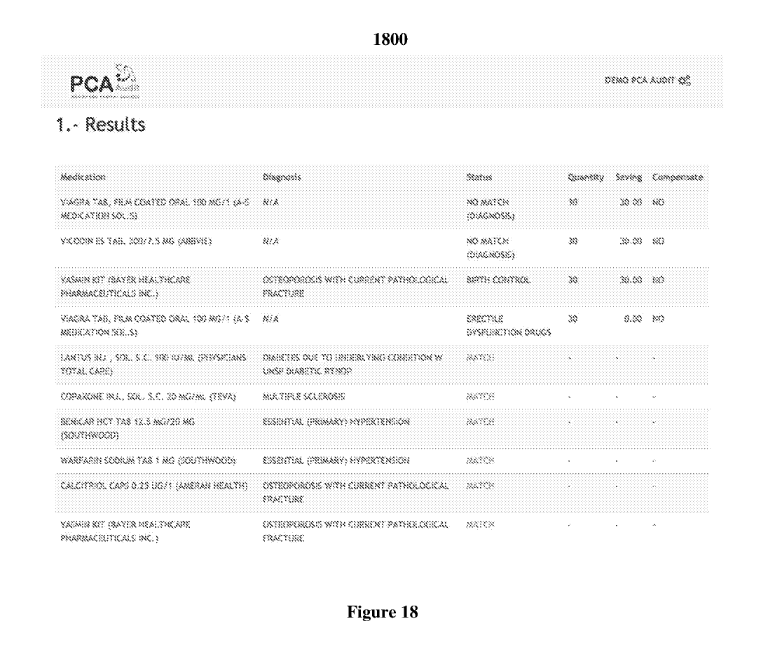

FIG. 15 illustrates an example screenshot of a user interface 1500 that may be presented to a user for entering claim data, patient data and/or a doctor's specialties, among other information. FIG. 16 illustrates an example screenshot of a user interface 1600 that may be presented to a user for entering indications for prescribed medications. FIG. 17 illustrates an example screenshot of a user interface 1700 that may be presented to a user for entering information from a pharmacy's invoice. FIG. 18 illustrates an example screenshot of a user interface 1800 that may be presented to a user for providing the user with results from PCA Audit processing. It should be appreciated that the disclosed embodiments are not to be limited by the example screenshots or any of the example figures reproduced herein.

It should be appreciated that the disclosed processing provides a technical advancement over existing health plan/insurance, etc. systems. The disclosed embodiments have a unique function that allows health plans to compare diagnosis versus prescriptions; identifying abuse, waste and misuse of pharmaceutical treatments in a manner that is currently not possible without the disclosed principles. Some implementations of the innovations described herein solve a problem necessarily rooted in today's technology that cannot compare and match diagnosis versus prescriptions, among other disclosed processing. The innovations provide a specific way to compare medical claims with prescription claims, matching diagnosis with prescription drugs, and diagnosis versus prescriptions, among other processing, to solve a problem faced by current systems.

In some embodiments, the disclosed systems and methods may provide one or more of the following features. By matching diagnosis with drugs before approving and dispensing a prescription drug to a patient, payers and health plans can reduce drug benefit costs. Automatic matching of diagnosis with drugs may allow large amounts of data (e.g., >100K diagnoses and >65K drugs) to be matched in time to provide real-time analysis at the point of care and/or distribution. Rather than auditing already processed claims to detect abuse and waste, abuse and waste may be detected in real time at the point of care. Because the analysis happens in real time, the output of the audit system described above may be used to block distribution of anomalous treatments. For example, anomalies and other warnings may be displayed to a user who may decide not to distribute improper treatments or may charge the patient for treatments not covered by insurance. In another example, the anomalies and other warnings may be fed directly to an automated prescription system so that improper drugs may be automatically blocked from distribution and/or the patient may be automatically charged. Accurate data may be generated identifying for which diagnoses drugs are being prescribed. Pharmacies may be able to process multiple prescriptions at the same time, optimizing the workflow and saving time. Prior authorization, wherein a pharmacy must communicate with the physician asking for a written consent approving dangerous treatments, off-label treatments, and very expensive treatments, may be replaced with real-time automated decision making. Uncoded patients (patients that don't have a proper diagnosis) may be identified automatically in real time at the point of care, rather than through inspection of previously processed claims.

The described features may be implemented advantageously in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method of auditing a medical treatment comprising:
receiving, at an audit system, data describing a transaction comprising one or more diagnoses and one or more treatments;
auditing, with the audit system, the transaction to identify a treatment within the one or more treatments that does not correspond to any of the one or more diagnoses;
generating, with the audit system, an anomaly report for the identified treatment; and
providing, with the audit system, the anomaly report to a treatment fulfillment system prior to fulfillment of the treatment, thereby preventing fulfillment of the treatment and/or changing an entity billed for the treatment.

2. The method of claim 1, wherein the auditing comprises matching at least one active ingredient in the treatment with at least one drug subclass and comparing the at least one drug subclass with at least one diagnosis subclass.

3. The method of claim 2, wherein a treatment corresponds to a diagnosis when the at least one drug subclass matches the at least one diagnosis subclass.

4. The method of claim 1, wherein the auditing further comprises identifying a treatment matching an evaluated anomaly.

5. The method of claim 1, wherein the auditing further comprises identifying a treatment matching a birth control anomaly diagnosis.

6. The method of claim 1, wherein the auditing further comprises identifying a treatment matching an erectile dysfunction anomaly diagnosis.

7. The method of claim 1, wherein:
the auditing further comprises comparing a prescribed treatment dose in the transaction with a maximum allowable dose to identify an overdose condition; and
the generating further comprises generating an anomaly report for the overdose condition.

8. The method of claim 1, wherein:
the auditing further comprises comparing a prescribed treatment duration in the transaction with a maximum allowable frequency to identify an excessive frequency condition; and
the generating further comprises generating an anomaly report for the excessive frequency condition.

9. The method of claim 1, wherein an anomaly described in the anomaly report comprises at least one of the following: the treatment does not match any of the one or more diagnoses; missing diagnosis; the treatment is not for a patient identified in the transaction; opioid abuse; a drug interaction; a prescription of a weight loss product; a prescription of an erectile dysfunction product; a prescription of a multivitamin; a prescription of an herbal product; a prescription of a product to treat tobacco addiction; a prescription of a skin care product; a prescription of a sedative or anxiolytic; a prescription of a non-pharmaceutical product; a prescription of a product to treat alcohol addiction; a prescription of a product to treat opioid addiction; a prescription of a product not covered by a health plan identified in the transaction; a prescription of a drug at an overdose level; a prescription of a birth control drug; a prescription of a nutritional supplement; a prescription of an appetite stimulant; a prescription of a homeopathic product; a prescription of an adaptogen; a prescription wherein a directed amount for the prescription exceeds a maximum allowed amount; at least one diagnosis that is not covered by the health plan; a doctor's specialty identified in the transaction that does not relate to at least one diagnosis.

10. An audit system for auditing a medical treatment comprising:
an processor configured to:
receive data describing a transaction comprising one or more diagnoses and one or more treatments;
audit the transaction to identify a treatment within the one or more treatments that does not correspond to any of the one or more diagnoses;
generate an anomaly report for the identified treatment; and
provide the anomaly report to a treatment fulfillment system prior to fulfillment of the treatment, thereby preventing fulfillment of the treatment and/or changing an entity billed for the treatment.

11. The audit system of claim 10, wherein the processor is configured to audit the transaction by matching at least one active ingredient in the treatment with at least one drug subclass and comparing the at least one drug subclass with at least one diagnosis subclass.

12. The audit system of claim 11, wherein a treatment corresponds to a diagnosis when the at least one drug subclass matches the at least one diagnosis subclass.

13. The audit system of claim 10, wherein the processor is further configured to audit the transaction by identifying a treatment matching an evaluated anomaly.

14. The audit system of claim 10, wherein the processor is further configured to audit the transaction by identifying a treatment matching a birth control anomaly diagnosis.

15. The audit system of claim 10, wherein the processor is further configured to audit the transaction by identifying a treatment matching an erectile dysfunction anomaly diagnosis.

16. The audit system of claim 10, wherein:
the processor is further configured to audit the transaction by comparing a prescribed treatment dose in the transaction with a maximum allowable dose to identify an overdose condition; and
the processor is further configured to generate the audit report by generating an anomaly report for the overdose condition.

17. The audit system of claim 10, wherein:
the processor is further configured to audit the transaction by comparing a prescribed treatment duration in the transaction with a maximum allowable frequency to identify an excessive frequency condition; and
the processor is further configured to generate the audit report by generating an anomaly report for the excessive frequency condition.

18. The audit system of claim 10, wherein an anomaly described in the anomaly report comprises at least one of the following: the treatment does not match any of the one or more diagnoses; missing diagnosis; the treatment is not for a patient identified in the transaction; opioid abuse; a drug interaction; a prescription of a weight loss product; a prescription of an erectile dysfunction product; a prescription of a multivitamin; a prescription of an herbal product; a prescription of a product to treat tobacco addiction; a prescription of a skin care product; a prescription of a sedative or anxiolytic; a prescription of a non-pharmaceutical product; a prescription of a product to treat alcohol addiction; a prescription of a product to treat opioid addiction; a prescription of a product not covered by a health plan identified in the transaction; a prescription of a drug at an overdose level; a prescription of a birth control drug; a prescription of a nutritional supplement; a prescription of an appetite stimulant; a prescription of a homeopathic product; a prescription of an adaptogen; a prescription wherein a directed amount for the prescription exceeds a maximum allowed amount; at least one diagnosis that is not covered by the health plan; a doctor's specialty identified in the transaction that does not relate to at least one diagnosis.
